(19) United States
(12) Patent Application Publication
(10) Pub. No.: US 2026/0252128 A1
(43) Pub. Date: Aug. 27, 2026

(54) Silo Bin Detection, Monitoring, and Analysis

(71) Applicant: LuxTronic, Inc., Centennial, CO (US)

(72) Inventors: Paul George, Denver, CO (US); James C. Evans, Englewood, CO (US); Christopher J. Piekarski, Broomfield, CO (US); Christopher Couture Del Valle, Cleveland Heights, OH (US); Luis Ochoa, Denver, CO (US)

(21) Appl. No.: 19/541,022

(22) Filed: Feb. 16, 2026

Related U.S. Application Data
(60) Provisional application No. 63/759,052, filed on Feb. 15, 2025.

(51) Int. Cl. G05D 9/12; G05B 13/02; G06K 7/14; G06K 19/06; E21B 41/00

(52) U.S. Cl. CPC G05D 9/12; G05B 13/0265; G06K 7/1417; G06K 19/06037; E21B 41/00

(57) ABSTRACT

This disclosure provides methods and systems for bin detection and fill event analysis for a silo bin during a fill event at a filling bay. Some aspects relate to a fill event analysis system performing an image detection analysis on frames taken from a continuous image stream of the bin during the fill event to capture a character sequence written on the bin. The bin detection analysis can be performed by a neural network trained to detect characters as images. Once the character images are detected, the system can associate each character into the character sequence and associate the sequence with the bin. The system is further configured to perform an analysis on the fill event by analyzing captured images of the filling process and the weight of the bin during the fill event to detect potential errors or faults and perform corrective actions.

### BACKGROUND

This disclosure relates to silo bin detection, monitoring, and analysis, more specifically, to silo bin detection, monitoring the filling operation, and progression analysis during a filling event.

Silo bins are typically large, modular, steel containers used to hold materials, such as frac sand, for on-site storage at an operation site, such as an oil and gas site. These bins are capable of holding substantial volumes of sand. They are designed to optimize the flow of sand into the mixing equipment, minimizing dust and spillage. The modular nature allows for scalability based on the size of the operation and can assist in streamlining operations by improving logistical efficiency.

The process of filling silo bins with material, such as sand, can involve using bottom drop trailers that offload the sand directly into the bins. These bins are designed to be portable, allowing for transport to different locations, such as a filling location. Once positioned, the trailers release sand directly into the bins through controlled openings or hoppers.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method of silo bin detection and analysis during a fill event of a bin by a filling bay. The method includes detecting a fill event associated with a bin positioned within a filling bay and receiving image frames captured by a camera positioned adjacent to the bin and associated with the filling bay. The method also includes generating bounding boxes around characters detected on the bin by inputting the image frames into a machine learning model and predicting labeled characters within each of the bounding boxes by inputting a section of the image frames associated with each of the bounding boxes into a second machine learning model. The method further includes concatenating the labeled characters produced the second machine learning model into a label string, queueing the label string into a double-ended queue (deque) data structure over a period, calculating median values for each of the labeled characters across each character position in the deque data structure, and generating a predicted serial number using the median values of the labeled characters.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The systems, methods, and devices of this disclosure each have several innovative aspects, no single one of which is solely responsible for the desirable attributes disclosed herein.

FIG. 1 illustrates an exemplary bin detection and analysis system for performing a bin detection on a bin during a fill event at a filling bay, in accordance with embodiments of the present disclosure.

FIG. 2 illustrates an exemplary machine learning module, in accordance with embodiments of the present disclosure.

FIG. 3 illustrates an exemplary automated bin filling layout capable of performing embodiments described herein, in accordance with embodiments of the present disclosure.

FIG. 4 illustrates an exemplary automated bin filling layout capable of performing embodiments described herein, in accordance with embodiments of the present disclosure.

FIG. 5 illustrates a flowchart for bin detection by detecting a serial number written on the bin using the bin detection and analysis system, in accordance with embodiments of the present disclosure.

FIG. 6 illustrates a block diagram of an exemplary computing device, in accordance with embodiments of the present disclosure.

FIG. 7 is a state chart illustrating an example fill-event state machine that coordinates scale-based bin detection, OCR gating, tare/zeroing, fill-in-progress monitoring, fill completion, post-fill reporting, and error/recovery operations, in accordance with embodiments of the present disclosure.

FIG. 8 is a sequence diagram illustrating an example inter-process workflow in which a weigh-system client streams raw scale samples to a main fill coordinator, in accordance with embodiments of the present disclosure.

FIG. 9 is a block diagram illustrating an example OCR pipeline including frame acquisition with fill-window gating, in accordance with embodiments of the present disclosure.

FIG. 10 is an illustrative diagram showing an example OCR camera frame annotated with per-character bounding boxes, in accordance with embodiments of the present disclosure.

FIG. 11 is a flow diagram illustrating an example failure-handling and fallback workflow for bin identification during a fill event, in accordance with embodiments of the present disclosure.

FIG. 12 is a block diagram illustrating an example data-plane architecture in which raw scale telemetry is stored in a time-series data store, in accordance with embodiments of the present disclosure.

FIG. 13 is a block diagram illustrating an example overfill-prevention loop in which an above-bin camera provides images to a fill level estimator, in accordance with embodiments of the present disclosure.

While the present disclosure is amenable to various modifications and alternative forms, specifics thereof, have been shown by way of example in the drawings and will be described in detail. It should be understood, however, that the intention is not to limit the particular embodiments described. On the contrary, the intention is to cover all modifications, equivalents, and alternatives falling within the scope of the present disclosure. Like reference numerals are used to designate like parts in the accompanying drawings.

### DETAILED DESCRIPTION

This disclosure relates to silo bin detection, monitoring, and analysis, more specifically, to silo bin detection during a filling operation, monitoring the filling operation, and performing various analyses associated with the bin and the filling operation. The following description is directed to some particular examples for the purpose of describing innovative aspects of this disclosure. However, a person having ordinary skill in the art will readily recognize that the teachings herein can be applied in a multitude of different ways.

### Overview

Frac sand is an essential component in hydraulic fracturing (fracking) operations to extract oil and natural gas from underground rock formations. It serves as a proppant, holding open the fractures created by high-pressure fluid injections. At a fracking site, silo bins play a crucial role in storing and delivering large quantities of proppant, typically frac sand, that is used to keep fractures in the rock open after hydraulic pressure is applied to extract oil and gas.

The silo bins are often designed to release specific amounts of sand at controlled rates. This is critical because the sand needs to be mixed into the fracturing fluid (e.g., water, chemicals, additives) at precise ratios to ensure effective fracture propagation. After a silo bin is filled, it can be positioned to feed sand directly to blenders, which mix the sand with fracturing fluid. These blenders then pump the mixture downhole under high pressure to fracture the rock and prop open the fractures.

Monitoring the silo bins during operation can be crucial in hydraulic fracturing operations, where large quantities of sand are used as a proppant to keep fractures in rock formations open, allowing oil and gas to flow. Silo bin monitoring can involve tracking and monitoring the volume, weight, and quality of sand stored in the silos on-site. Some monitoring systems for frac sand silos can include sensors, cameras, and software to provide real-time data on sand levels, inventory, and flow.

For instance, level sensors can be installed inside or on top of the silos and can continuously measure the sand level, using radar, ultrasonic, or laser technology to track volume or weight. Flow monitoring can also be achieved by sensors placed at the discharge point to track the flow rate of sand moving out of the silo to ensure continuous supply to the fracking pumps.

Limitations on silo bin monitoring remain, however, as corrosion and wear can and do occur to the silo bins as they are used over time. When a silo bin fails during these operations, it can have significant consequences for operations that rely on a continuous flow of materials, like frac sand. The failures can stem from structural issues, mechanical malfunction, or operational errors, and often lead to severe safety, operational, and financial impacts. As an example, if a bin collapses or breaks, large quantities of material can spill out rapidly, posing a serious risk to nearby workers and equipment. Sand and other materials stored in silo bins can create dust clouds if they escape the silo rapidly. In enclosed or poorly ventilated areas, these dust clouds can ignite, leading to explosions.

Corrosion or erosion on and around the silo bins can also lead to poor monitoring as serial numbers written on each bin can wear over time. As these serial numbers become worn, monitoring equipment is unable to read the numbers and may incorrectly categorize these bins. If a bin is miscategorized or undocumented due to poor visibility of the serial number, then downstream monitoring tools may also fail to correlate corresponding data associated with the actual silo bin.

Various aspects of the disclosure improve existing technologies, as well as others, by providing methods, components, and systems that support the analysis of silo bins during operation. A bin detection and analysis system can provide automatic bookkeeping for inventory control of onsite bins based on fill events and serial number detections. The detection and analysis system can detect an initiation of a fill event by monitoring scale data from a filling bay. When a bin is positioned within the filling bay, the scale data will change to indicate that a fill event is about to occur. The filling bay will perform the fill event by placing materials into the bin until a predetermined weight is read by the scale. During the fill event, the detection and analysis system can capture a continuous image stream of the bin using a camera positioned adjacent to the bin and one that is associated with the filling bay. Using frames from the image stream, the detection and analysis system can perform an image detection analysis using a machine learning model using machine learning techniques. The machine learning techniques can predict a character sequence written on the bin. The character sequence determined by the machine learning model can be associated with the bin and can be used as the serial number for that bin. In some implementations, the bin detection and analysis system can detect corrosion, wear, and damage to the bins. Machine learning models can be used to detect these defects and generate an alert.

In some implementations, the detection and analysis system includes additional cameras deployed above the bin to determine real-time sand levels, prevent overfilling or bad accounting. Based on the image data captured by the camera, the detection and analysis system can analyze those images to detect potential issues with the bins that may require human intervention. In some embodiments, the camera can also be used to audit the expected remaining material compared to the fill values identified during the fill event.

Various aspects of the disclosure improve existing technologies, as well as others, by providing methods, components, and systems that support the analysis of a bin fill event of a bin occurring in a filling bay. A bin analysis can be performed on the bin to determine a serial number associated with the bin. Due to the nature of the process and the environment in which these bins operate, detecting the serial number on a bin can be difficult and prone to human error as the serial numbers can wear over time. The bin analysis can implement machine learning techniques to accurately predict the correct serial numbers for bins and associate the serial numbers to the bins. From that analysis, the serial numbers can be associated with the bins and the bin detection and analysis system can perform additional fill event analysis for the fill event occurring to the bin with the identified serial number. Based on the fill event analysis, various metrics and defect detections can be determined and can be accurately associated with the correct bin.

### Example Bin Detection and Analysis System

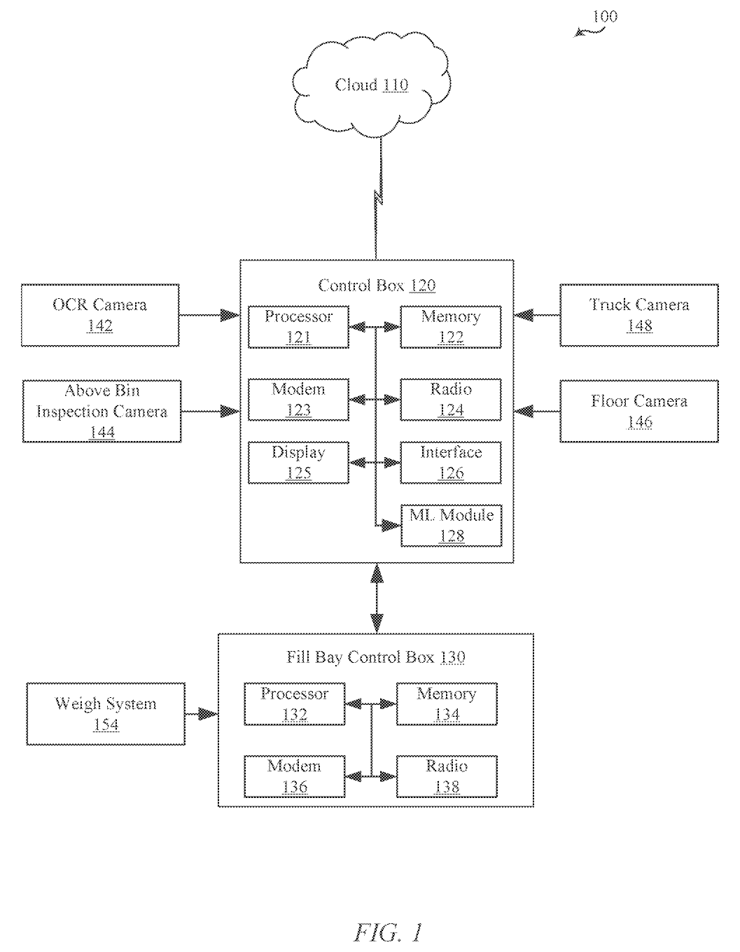

Referring now to FIG. 1, a block diagram of an example bin detection and analysis system 100 is shown. In embodiments, the system 100 is deployed at or near one or more fill bays and is configured to acquire image data associated with a bin and/or a fill operation, acquire weight information from a weigh system during a fill event, determine a bin identifier (e.g., via OCR and/or machine vision), and generate and/or report fill-event data (e.g., timestamps, net weight added, bay identifier, and other metadata). Although FIG. 1 depicts particular functional blocks, the illustrated partitioning is example only. In some embodiments, one or more blocks may be combined, subdivided, relocated (e.g., to the cloud 110), or omitted depending on site constraints and deployment objectives.

In the illustrated example, the system 100 includes a control box 120 in communication with a cloud computing environment 110. The cloud 110 may provide one or more backend services such as data storage (e.g., for telemetry and fill records), dashboards and reporting interfaces, remote configuration, model distribution/updates, device fleet management, and/or an API for integration with downstream enterprise systems. Communication between the control box 120 and cloud 110 may be performed using any suitable wired or wireless network connection, and may be continuous, periodic, event-driven, or opportunistic. In some embodiments, the control box 120 is configured to operate in a degraded or offline mode when cloud connectivity is unavailable (e.g., buffering records locally and uploading when connectivity resumes).

The control box 120 includes one or more computing resources such as processor 121 and memory 122. The processor 121 executes software instructions stored in memory 122 to implement system functionality, including orchestration of image acquisition, preprocessing, machine learning inference, event logic, and data packaging for reporting. The control box 120 further includes communication components such as a modem 123 and/or radio 124 for wide-area connectivity (e.g., cellular and/or other wireless backhaul) and may include a local network interface for communicating with on-site devices. The control box 120 may also include a display 125 and/or other interface 126 to support local user interaction (e.g., operator prompts, status indicators, configuration inputs, troubleshooting screens, and/or service-mode workflows). In embodiments, the control box 120 further includes a machine learning (ML) module 128, which may include one or more trained models and/or inference logic to analyze image data for tasks such as bin identification, inspection/condition assessment, fill-level estimation, vehicle detection, safety monitoring, or other site-specific analytics.

As shown, the control box 120 receives image data from one or more cameras. In the illustrated example, an OCR camera 142 provides imagery of bin-identifying indicia (e.g., printed characters, labels, or other markings) for determining a bin identifier. An above-bin inspection camera 144 may provide imagery of an interior or top region of the bin (e.g., to support fill-level estimation, overfill detection, or inspection of fill conditions). A floor camera 146 may provide imagery of a region near the bay floor (e.g., to support presence detection, alignment verification, safety zone monitoring, spill detection, or other environmental cues). A truck camera 148 may provide imagery associated with a vehicle servicing the bay (e.g., for vehicle presence/position verification and/or related monitoring tasks). In some embodiments, one or more of the cameras 142,144, 146, 148 are network cameras (e.g., PoE) and provide compressed video streams or still frames to the control box 120. In some embodiments, one or more cameras may be directly attached or may provide frames through an intermediate device.

The system 100 further includes a fill bay control box 130 coupled to the control box 120. In embodiments, the fill bay control box 130 is positioned proximate a fill bay and serves as an interface between bay-local equipment and the upstream processing performed by the control box 120. The fill bay control box 130 includes computing resources such as processor 132 and memory 134, and communication components such as modem 136 and/or radio 138. In the illustrated example, the fill bay control box 130 receives weight information from a weigh system 154. The weigh system 154 may include one or more scales, load cells, and/or associated controllers that produce scale samples (e.g., weight values with timestamps) and/or fill summary data. The fill bay control box 130 may forward raw or processed weight information to the control box 120, may time-align weight samples with image-derived events, and/or may support bay-local functions such as tare/zero coordination, detection of fill start/stop conditions, and generation of fill-event metadata for reporting.

In operation, the control box 120 may correlate image-derived outputs (e.g., a bin identifier determined from OCR camera 142 and/or other camera-derived context) with weight-derived outputs from the weigh system 154 (via the fill bay control box 130) to produce a consolidated fill-event record. The consolidated record may be stored locally and/or transmitted to the cloud 110 for persistence, reporting, and downstream integration. As described in further detail with respect to subsequent figures, the architecture of FIG. 1 supports separating time-sensitive scale/event logic from computationally intensive vision processing (e.g., via dedicated ML/OCR workflows), while maintaining reliable association between a particular bin and a particular fill event.

### Example Machine Learning Module

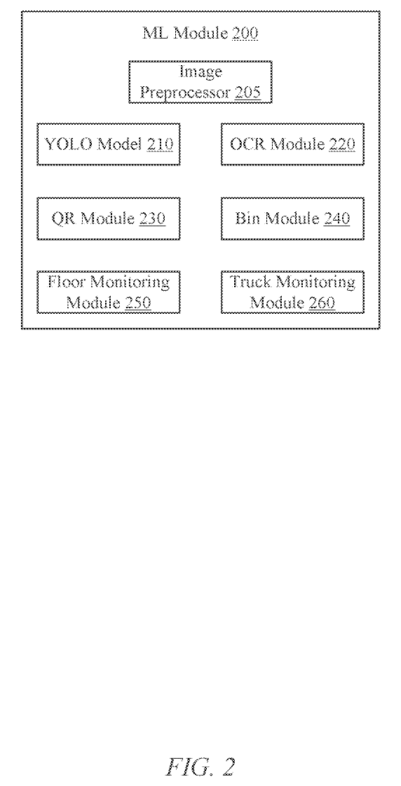

Referring now to FIG. 2, an example machine learning module 200 is shown. In embodiments, the machine learning module 200 is substantially similar to the machine learning module 128 of FIG. 1 and is implemented by one or more processors (e.g., processor 121 of the control box 120) to perform machine-vision analyses on image streams captured at or near one or more fill bays. In the illustrated example, the machine learning module 200 includes an image preprocessor 205, a region-of-interest (ROI) detection model 210 (e.g., a YOLO-type detector), an OCR module 220, a QR module 230, a bin module 240, a floor monitoring module 250, and a truck monitoring module 260. In some embodiments, the modules 205–260 may be executed concurrently (e.g., as separate threads or processes), and one or more modules may be enabled or disabled based on site configuration, available sensors, or operational mode.

The image preprocessor 205 is configured to condition raw frames for downstream inference. In embodiments, preprocessing includes one or more of resizing, normalization, cropping to a field-of-view or region-of-interest, and optional image enhancement (e.g., contrast/brightness adjustment) to improve robustness across lighting conditions, camera placement, and bin wear/debris. The image preprocessor 205 may be applied to frames from one or more cameras (e.g., OCR camera 142, above-bin camera 144, floor camera 146, and/or truck camera 148).

The ROI detection model 210 is configured to localize visual elements relevant to downstream tasks. In embodiments, the ROI detection model 210 receives preprocessed frames and outputs one or more bounding boxes (or other localization primitives) indicating regions likely to contain bin-identifying indicia (e.g., character regions on a bin label), machine-readable codes (e.g., QR codes), vehicles, people, and/or other objects of interest depending on the particular task. In some embodiments, the ROI detection model 210 is trained using labeled examples reflecting expected deployment conditions (e.g., varying illumination, rotation, dirt, and label wear) and provides bounding box coordinates and associated confidence scores for subsequent processing.

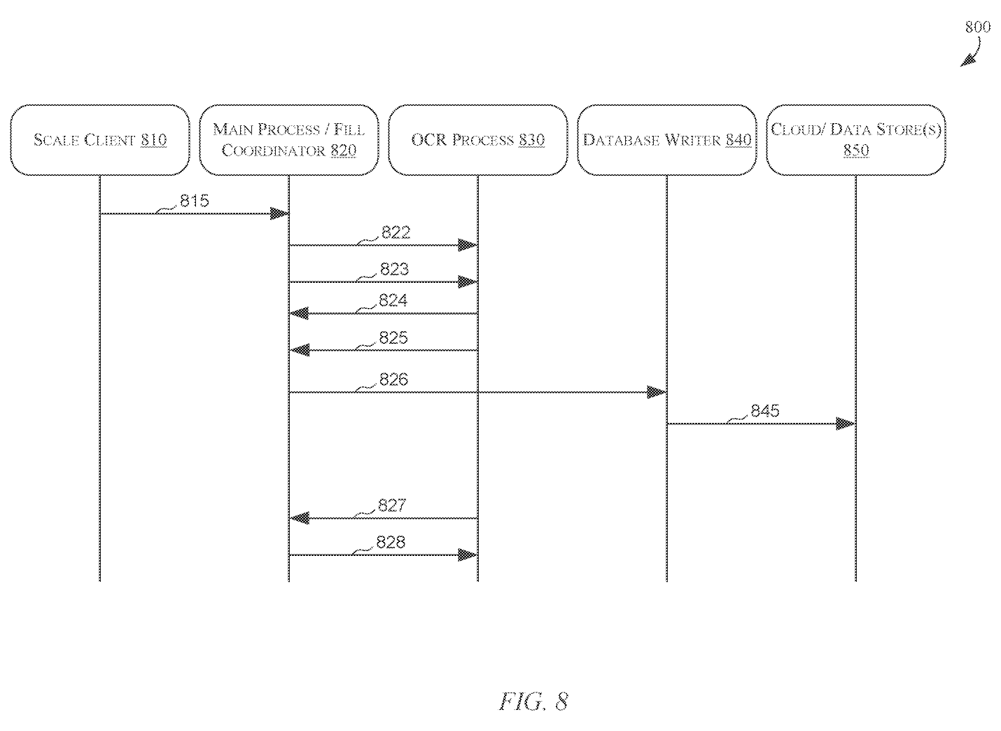

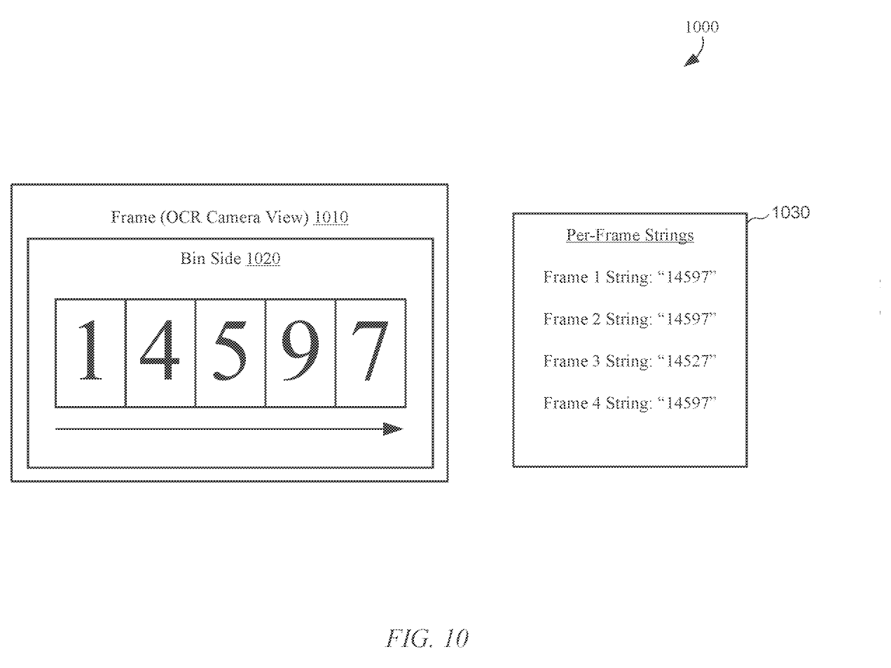

The OCR module 220 is configured to determine a bin identifier (or other identifier) from frames captured by the OCR camera 142. In embodiments, the OCR module 220 uses one or more ROIs output by the ROI detection model 210 to isolate regions containing characters and then performs character recognition to produce a candidate identifier string. The OCR module 220 may validate candidate strings using one or more constraints (e.g., expected length, allowed character set, or site-specific format rules), and may apply a multi-frame stabilization technique (e.g., buffering candidate strings over successive frames and selecting a consensus value) to reduce transient misreads. Example OCR pipelines, consensus techniques, and validation/finalization logic are described in greater detail with reference to FIGS. 8–11 (including the multi-frame consensus example of FIG. 10).

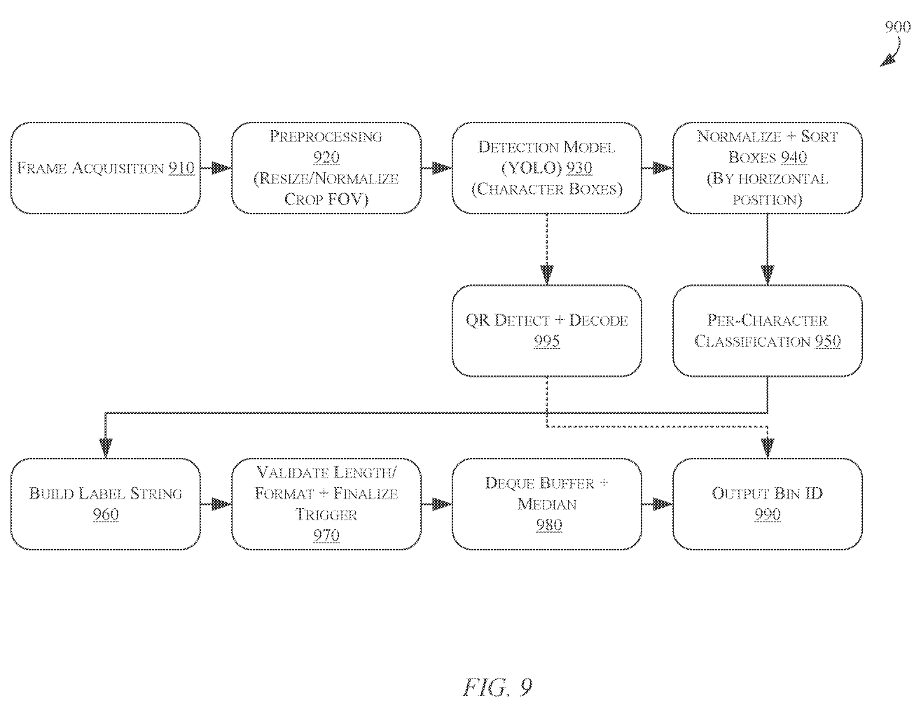

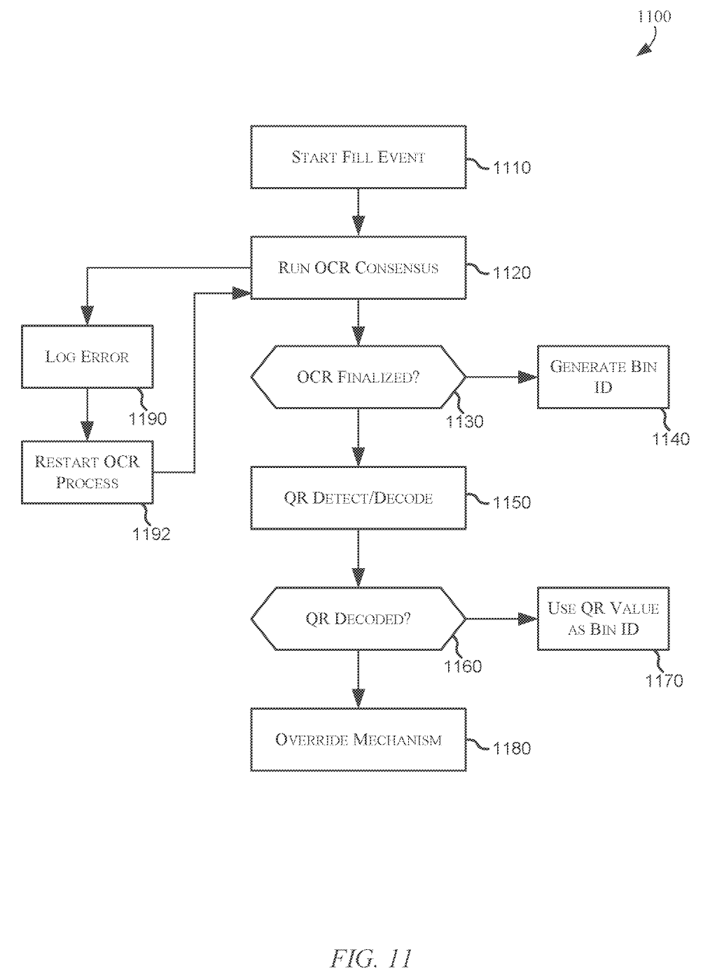

The QR module 230 is configured to detect and decode a QR code on the bin and, in some embodiments, to use decoded QR content as the bin identifier. In embodiments, the QR module 230 operates on frames (or ROIs) from the ROI detection model 210 and attempts to decode a QR payload when present. In some implementations, QR decoding is used as an alternative or fallback to character-based OCR (e.g., when OCR does not finalize or does not satisfy validation criteria), as described in greater detail with reference to FIGS. 9 and 11.

The bin module 240 is configured to perform bin-related monitoring associated with the fill process. In some embodiments, the bin module 240 receives image data from the above-bin camera 144 and estimates fill level and/or remaining capacity (e.g., using segmentation and/or depth estimation). The bin module 240 may generate alerts or stop-filling outputs when a predicted or detected overfill condition is present, and may optionally fuse image-derived estimates with weigh-system data (e.g., weigh system 154) to improve reliability.

The floor monitoring module 250 is configured to monitor activity in and around a fill bay using imagery from the floor camera 146. In embodiments, the floor monitoring module 250 detects objects such as forklifts and people and can generate safety-related outputs (e.g., proximity alerts, restricted-zone alerts, and/or collision-risk alerts) based on object detections and/or tracking over time.

In some embodiments, the system computes a proximity metric (e.g., a distance between detected object centroids or bounding boxes) between a forklift and a person and generates an unsafe-condition alert when the metric falls below a threshold (optionally satisfied for a dwell time) and/or when either object enters a restricted zone.

The truck monitoring module 260 is configured to detect and analyze trucks associated with unloading and/or material supply operations using imagery from the truck camera 148. In embodiments, the truck monitoring module 260 detects truck presence and may identify a particular truck (e.g., via visible identifiers) and associate truck activity with time and location. In some implementations, outputs of the truck monitoring module 260 are used to generate delivery records (e.g., a digital bill of lading) and/or to associate inbound material deliveries with subsequent fill events.

In some embodiments, visible truck identifiers include a license plate number, a DOT number, a fleet unit number, and/or a trailer number, which may be extracted using OCR/ALPR techniques. Delivery records (e.g., digital bills of lading) may include the truck identifier and one or more delivery fields such as arrival/departure time, site/geofence identifier, material type, and/or delivered quantity.

In embodiments, outputs produced by the machine learning module 200 (e.g., bin identifiers, fill-level estimates, safety alerts, and/or truck events) are provided to event coordination logic (e.g., a fill coordinator) and stored locally and/or transmitted to a remote system (e.g., cloud 110) as part of fill-event records and associated telemetry, as described in greater detail with reference to later figures.

### Example Bin Layouts

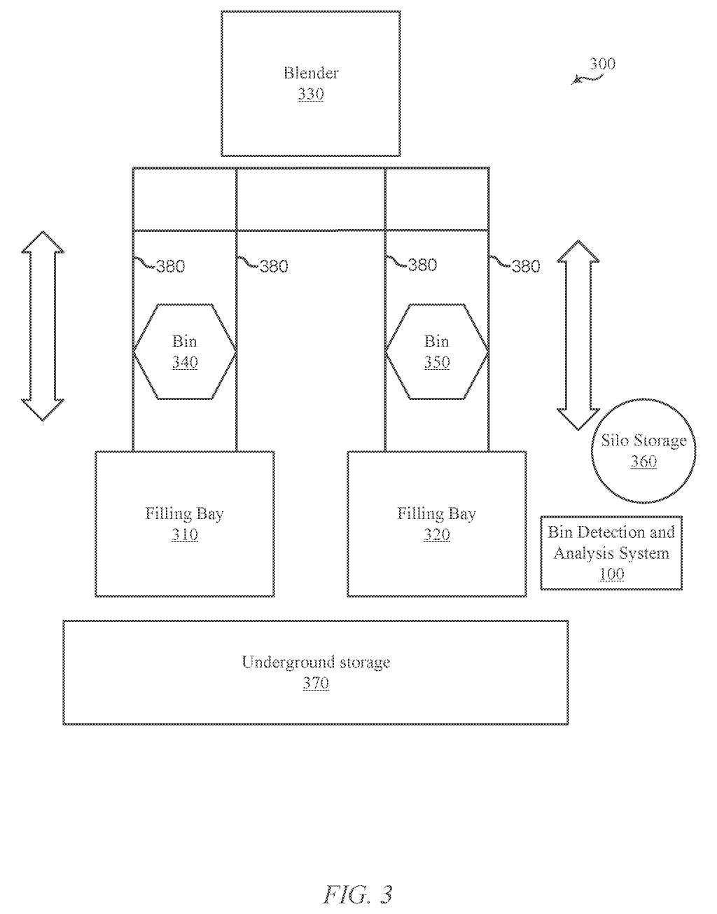

FIG. 3 illustrates an exemplary automated bin filling layout 300 and operation of bins and filling bays using an automated system of sand bin management, in accordance with embodiments of the present disclosure. The automated bin filling layout 300 includes the bin detection and analysis system 100, filling bays 310, 320, a blender 330, bins 340, 350, a silo storage 360, and an underground storage 370. The automated bin filling layout 300 can represent a configuration in which the bin detection and analysis system 100 can operate and further automate the bin filling process.

The filling bays 310 represent bays used to fill the bins 340, 350 with materials such as sand used in fracking operations. The bins 340, 350 are connected to the rails 380 such that they are able to move along the rails from the filling bays 310, 320 to the blender 330.

As an example, the rails 380 enable movement of the bins 340, 350. Using the rails 380, embodiments of the bin detection and analysis system 100 can automate bin rotation to supply sand to the blender 330. The bin detection and analysis system 100 can dynamically create a real-time, on-site bill of lading (BOL) based on the sand weight in each bin. In some implementations, the bin detection and analysis system 100 utilizes machine learning models to calculate demand and automate the sand filling process and transport the bins 340, 350 to the blender based on demand. Optional storage 360 and underground storage 370 allow this layout to further scale up based on the demand required at a site.

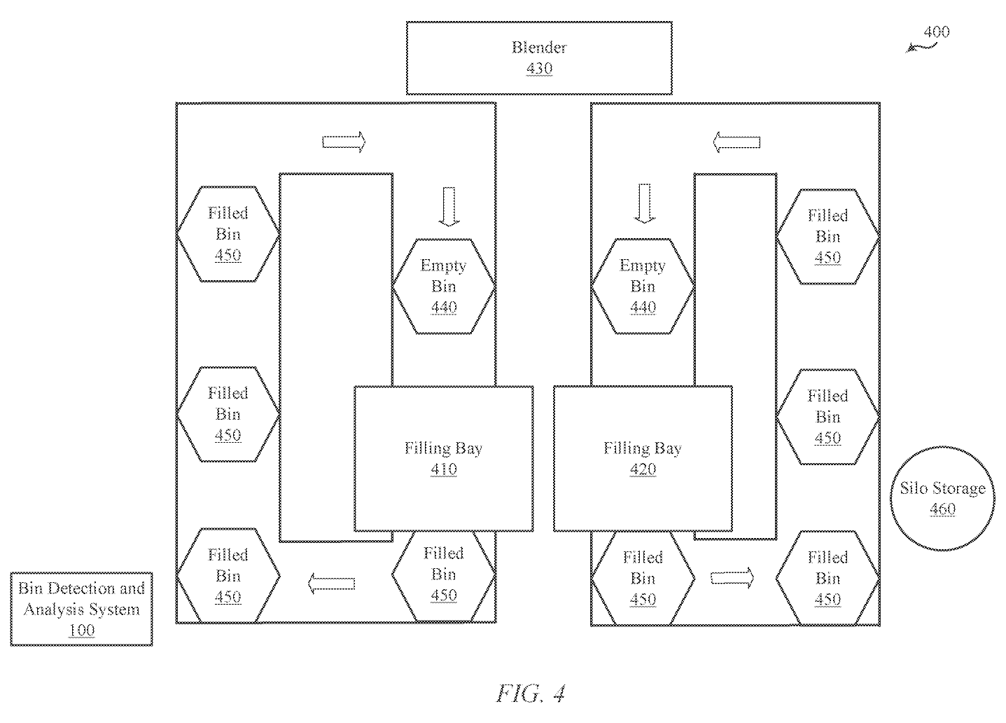

FIG. 4 illustrates an exemplary automated bin filling layout 400 and operation of bins and filling bays using an automated system of sand bin management, in accordance with embodiments of the present disclosure. The automated bin filling layout 400 includes the bin detection and analysis system 100, filling bays 410, 420, a blender 430, empty bins 440, filled bins 450, and a silo storage 460. The automated bin filling layout 400 can represent a configuration in which the bin detection and analysis system 100 can operate and further automate the bin filling process.

As an example, the rails enable circular movement of the bins 440, 450. Using the rails, embodiments of the bin detection and analysis system 100 can automate bin rotation to supply sand to the blender 430. The bin detection and analysis system 100 can dynamically create a real-time, on-site BOL based on the sand weight in each bin. In some implementations, the bin detection and analysis system 100 utilizes machine learning models to calculate demand and automate the sand filling process and transport the bins 440, 450 to the blender based on demand. Optional silo storage 460 allows this layout to further scale up based on the demand required at a site.

Thus, the illustrative embodiments in FIGS. 1-4, described herein, provide various improvements over conventional methods. For example, embodiments offer a precise detection of a bin during the filling process and additional analysis of the bin filling process by performing automated monitoring associated with the fill material and the bin. By leveraging camera data and machine learning techniques, the bin monitoring and analysis system 100 can identify bin serial numbers and associate those bins with sand filling processes. The association can assist in determining issues with a specific bin that may occur during the filling process. Based on that analysis, a determination can be made as to whether intervention is required by on-site workers.

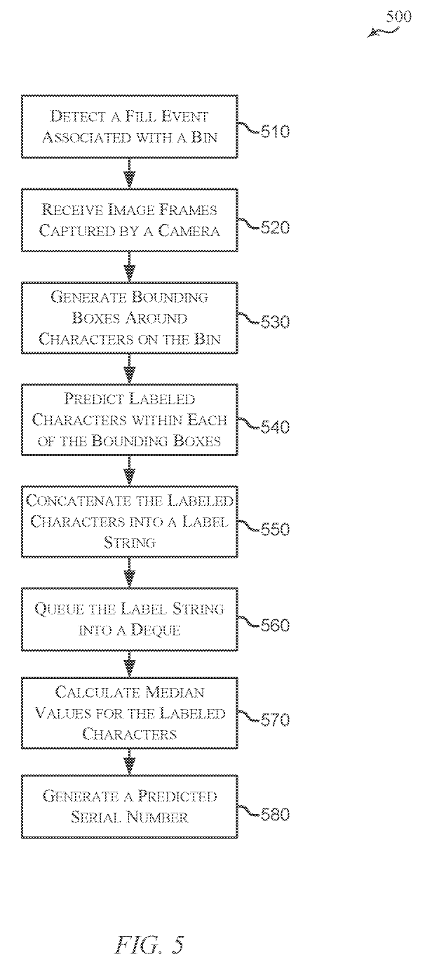

In addition to the foregoing, embodiments can also be described in terms of flowcharts comprising acts and steps in a method for accomplishing a particular result. For example, FIG. 5 illustrates a flowchart of exemplary methods in accordance with one or more embodiments. The method described in relation to FIG. 5 can be performed with fewer or more steps/acts or the steps/acts can be performed in differing orders. Additionally, the steps/acts described herein can be repeated or performed in parallel with one another or in parallel with different instances of the same or similar steps/acts.

### Example Flow Diagram

FIG. 1, the corresponding text, and the examples provide a number of different systems that provide a bin detection and analysis system capable of detecting serial numbers attached to bins despite varying degrees of degradation that may have occurred to the serial number. In addition to the foregoing, embodiments can also be described in terms of flowcharts comprising acts and steps to accomplish a particular result. For example, FIG. 5 illustrates a flowchart of an exemplary method in accordance with one or more embodiments. The method described in relation to FIG. 5 may be performed with fewer or more steps/acts, or the steps/acts may be performed in differing orders. Additionally, the steps/acts described herein may be repeated or performed in parallel with one another or in parallel with different instances of the same or similar steps/acts.

With reference to FIG. 5, a flow diagram illustrating a method is provided. Each block of the method 500 and any other methods described herein comprise a computing process performed using any combination of hardware, firmware, and/or software. For instance, in some embodiments, various functions are carried out by a processor executing instructions stored in memory. In some cases, the methods are embodied as computer-usable instructions stored on computer storage media. In some implementations, the methods are provided by a standalone application, a service or hosted service (standalone or in combination with another hosted service), or a plug-in to another product, to name a few.

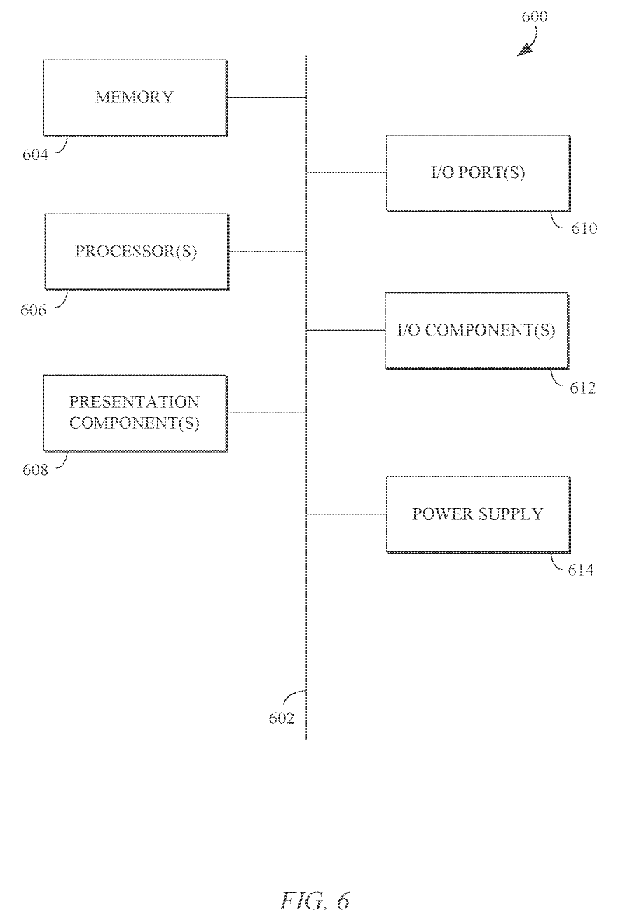

FIG. 5 shows a flowchart illustrating an example process 500 performable by or at a computing device that supports bin detection and analysis on a bin during a bin filling process performed by a filling bay. For example, the process 500 may be performed by a computing device, such as the computing device 600 described with reference to FIG. 6.

In some examples, the computing device is configured to perform the process 500 described with reference to FIG. 5. At block 510, the computing device detects a fill event associated with a bin. In some implementations, the fill event can be detected using a weight change of a scale on a filling bay. The weight change can indicate that a bin is placed within the bay to initiate the fill event.

At block 520, the computing device receives image frames from a continuous stream of images captured by a camera positioned adjacent to the bin and associated with the filling bay. The camera’s position can be such that the captured images display a side of the bin. In some implementations, multiple cameras can be positioned along the filling bay allowing for each side of the bin to be captured by at least one camera.

At block 530, the computing device generates bounding boxes around characters detected within the image frames captured by the camera. The characters can be characters written onto the bin that represent the serial number of the bin. In some implementations, the computing device implements a YOLO model using machine learning techniques to generate a bounding box around each character detected on the bin.

At block 540, the computing device predicts labeled characters for the bounding boxes. Each portion of the image around the bounding boxes can be inputted into a machine learning model that is trained to predict characters as objects. Once ingested by the model, the output can be a predicted labeled character. At block 550, the computing device concatenates these predicted labels into a label string such that they correspond to the order in which they are written on the bin.

At block 560, the computing device queues the labeled string into a deque data structure. The computing device repeats blocks 520-560 over a predetermined period to fill the deque data structure with labeled strings. At block 570, the computing device calculates a median value for each character in its respective character order using the deque data structure. At block 580, the computing device generates a predicted serial number using the median values for each character in its respective character order.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general purpose or special purpose computer.

A "network" is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links that can be used to carry desired program code means in the form of computer-executable instructions or data structures and which can be accessed by a general-purpose or special-purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a "NIC"), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special-purpose computer, or special-purpose processing device to perform a certain function or group of functions. In some embodiments, computer-executable instructions are executed on a general-purpose computer to turn the general-purpose computer into a special-purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including personal computers, desktop computers, laptop computers, message processors, handheld devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, "cloud computing" is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, software as a Service ("SaaS"), platform as a Service ("PaaS"), and Infrastructure as a Service ("IaaS"). A cloud computing model can also be deployed using different deployment models such as private cloud, community cloud, public cloud, hybrid cloud, and so

forth. In this description and in the claims, a "cloud-computing environment" is an environment in which cloud computing is employed.

### Example Operating Environment

Having described an overview of embodiments of the present technology, an example operating environment in which embodiments of the present technology may be implemented is described in order to provide a general context for various aspects of the present technology. Referring now to FIG. 6, in particular, an exemplary operating environment for implementing embodiments of the present technology is shown and designated generally as computing device 600. Computing device 600 is but one example of a suitable computing environment and is not intended to suggest any limitation as to the scope of use or functionality of the technology. Neither should computing device 600 be interpreted as having any dependency or requirement relating to any one or combination of components illustrated.

The technology of the present disclosure may be described in the general context of computer code or machine-useable instructions, including computer-executable instructions such as program modules, being executed by a computer or other machines, such as a personal data assistant or other handheld devices. Generally, program modules, including routines, programs, objects, components, data structures, etc., refer to code that performs particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 6, computing device 600 includes bus 602 that directly or indirectly couples the following devices: memory 604, one or more processors 606, one or more presentation components 608, input/output ports 610, input/output components 612, and illustrative power supply 614. Bus 602 represents what may be one or more buses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component, such as a display device, or an I/O component. Also, processors have memory. We recognize that such is the nature of the art and reiterate that the diagram of FIG. 6 merely illustrates an example computing device that can be used in connection with one or more embodiments of the present technology. A distinction is not made between such categories as "workstation," "server," "laptop," "hand-held device," etc., as all are contemplated within the scope of FIG. 6 and reference to "computing device."

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media.

Computer storage media include volatile and nonvolatile, removable, and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 600. Computer storage media excludes signals per se.

Communication media typically embodies computer-readable instructions, data structures, program modules, or other data in a modulated data signal such as a carrier wave or other transport mechanism and includes any information delivery media. The term "modulated data signal" means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 604 includes computer storage media in the form of volatile or nonvolatile memory. The memory may be removable, non-removable, or a combination thereof. Examples of hardware devices include solid-state memory, hard drives, optical-disc drives, etc. Computing device 600 includes one or more processors that read data from various entities, such as memory 604 or I/O components 612. Presentation component(s) 608 presents data indications to a user or other device. Examples of presentation components include a display device, speaker, printing component, vibrating component, etc.

I/O ports 610 allow computing device 600 to be logically coupled to other devices, including I/O components 612, some of which may be built in. Illustrative components include a microphone, joystick, game pad, satellite dish, scanner, printer, wireless device, sensors, etc.

### Example State Machines

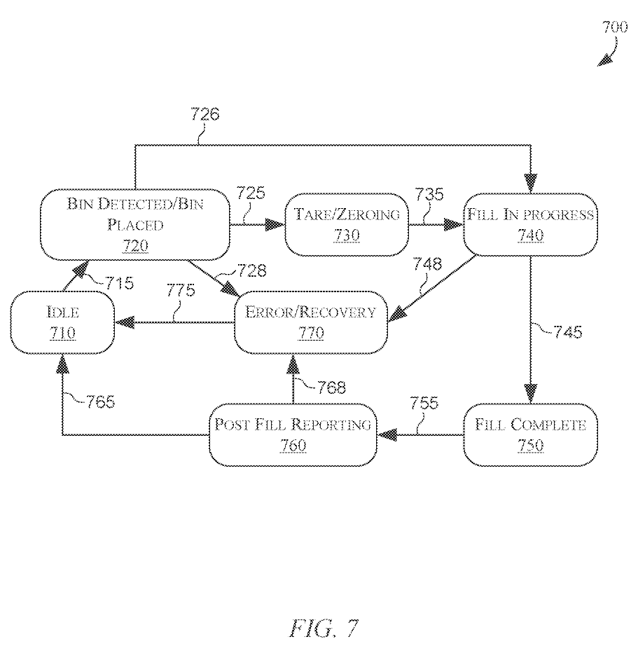

FIG. 7 illustrates an example fill-event state machine (or state chart) 700 for coordinating scale-based fill-event detection, OCR gating, and fill completion and reporting for a bin positioned in (or otherwise associated with) a filling bay. In embodiments, the state machine 700 is implemented by a processing system of the bin detection and analysis system (e.g., a control box and/or a fill-bay control box) and is driven at least in part by weight information from a weigh system and by OCR status for determining a bin identifier (e.g., a serial number) to be associated with a particular fill event.

In the illustrated example, the state machine 700 includes an idle state 710, a bin detected/placed state 720, a tare/zeroing state 730, a fill in progress state 740, a fill complete state 750, a post fill reporting state 760, and an error/recovery state 770. As shown, the state machine 700 transitions between these states based on one or more criteria derived from the weigh system (e.g., weight changes, tare-band checks, and target-weight checks), OCR results (e.g., OCR OK vs. OCR fail/timeout), and post-fill data availability (e.g., receipt of a fill data packet and record-write completion).

In idle 710, the system may monitor incoming weight information from the weigh system to detect when a bin is positioned within the filling bay. In some examples, transition 715 from idle 710 to bin detected/placed 720 occurs when a weight change exceeds a threshold for at least a dwell time, which can reduce false triggers due to noise, transient disturbances, or momentary contact. In some implementations, this “weight change” detection corresponds to detecting a fill event using a scale change indicating that a bin has been placed in the bay to initiate the filling process.

In bin detected/placed 720, the system may establish fill-event context and initiate or enable OCR gating such that OCR processing is performed (or OCR results are accepted) to identify the bin. In some examples, OCR processing is performed by an OCR pipeline that is separate from a main scale-ingress process (e.g., separate process or thread) and communicates OCR results to the scale-ingress logic via a queue or other inter-process mechanism. In the illustrated example, the state machine 700 transitions 725 out of bin detected/placed 720 when an OCR OK condition is satisfied. If OCR fails, times out, or otherwise faults (as indicated by the “OCR fail / timeout / fault” path), the state machine 700 transitions 728 to error/recovery 770.

When OCR is successful, FIG. 7 shows two example paths into filling. In a first path, the system transitions 725 from bin detected/placed 720 to tare/zeroing 730 upon OCR OK with tare requested. In a second path, the system transitions 726 from bin detected/placed 720 directly to fill in progress 740 upon OCR OK & start fill (tare not required). In some implementations, the tare-requested path is used when a measured weight is within a predetermined tare-weight range (also referred to herein as a “tare band”) and the system performs a tare-to-zero operation before filling begins.

In tare/zeroing 730, the system may perform, request, or verify a tare-to-zero operation (or another reference/zeroing operation) for the weigh system. In some examples, the system remains in tare/zeroing 730 until the measured weight is within a tare band, indicating that the weigh system has stabilized at a suitable reference condition. Upon satisfaction of the tare-band criterion, the state machine 700 transitions 735 to fill in progress 740. The illustrated bidirectional relationship between the tare/zeroing region and the fill-in-progress region may represent, in some embodiments, that the system can re-enter a tare/zeroing operation responsive to operational conditions (e.g., re-tare request, out-of-band condition, or other verification logic), without requiring re-entry to the initial bin-detected state.

In fill in progress 740, the system monitors weight information while the filling bay introduces material into the bin. In embodiments, the OCR-derived bin identifier determined during bin detected/placed 720 (and optionally verified during subsequent states) is maintained as part of the fill-event context so that weight information and other fill analytics can be associated with the correct bin. In some examples, the fill-in-progress monitoring includes detecting fill completion based on a predetermined target weight. In additional or alternative examples, fill completion is determined based on a rate-of-change condition, such as when a computed rate of change of measured weight over time falls below a threshold, which may indicate that material flow has slowed or stopped.

Upon satisfaction of a fill-completion criterion, the state machine 700 transitions 745 from fill in progress 740 to fill complete 750. In some implementations, entering fill complete 750 corresponds to generation of, or readiness to generate, a stop-filling alert and/or other control output associated with the filling bay. In some examples, the system also begins awaiting post-fill data availability (e.g., a “fill data packet” generated or provided after a fill event is detected as complete).

From fill complete 750, FIG. 7 shows transition 755 to post fill reporting 760 when a fill data packet is received and a record is written. In some implementations, the “fill data packet” is distinct from raw, continuously streamed scale values, and may be produced after completion of the fill event (e.g., triggered by fill-event detection logic based on the raw data). In some examples, the reporting operation includes writing or updating a fill record that binds the bin identifier determined via OCR, fill metrics derived from the weigh system, and associated metadata. In some examples, the system stores time-series data in a time-series data store and stores fill records in a relational data store, optionally including additional metadata such as a geofence determination based on GPS information.

In post fill reporting 760, the system may complete record finalization, storage, and/or communication of the fill event to downstream systems. In the illustrated example, the state machine 700 transitions 765 from post fill reporting 760 back to idle 710 upon record stored / bay cleared, which can include detecting that the bay has been cleared (e.g., the bin is removed and weight returns toward an idle baseline) and that the fill record has been successfully persisted. If a reporting fault occurs (e.g., record fail / timeout and/or other fault/timeout conditions indicated in FIG. 7), the state machine 700 transitions 768 to error/recovery 770.

In error/recovery 770, the system may implement recovery actions such as resetting state, restarting an OCR process, reinitializing interfaces, and/or triggering manual intervention. Upon a reset / recovered condition, the state machine 700 transitions 775 back to idle 710 to resume monitoring for subsequent fill events. As indicated by the note in FIG. 7, in some implementations the state machine 700 is executed per bay (e.g., per filling station) such that multiple fill stations may be monitored concurrently using separate instances of the state machine logic.

### Example Sequence Diagram

FIG. 8 illustrates an example sequence diagram 800 showing an example inter-process (or inter-thread) workflow for coordinating scale-data ingestion, OCR-based bin identification, and fill-event record generation/reporting. In embodiments, the sequence diagram 800 represents an implementation approach in which scale ingestion and fill coordination are performed in a main process while OCR is performed in a separate OCR process to reduce latency and avoid blocking time-sensitive scale/event logic.

In the illustrated example, a weigh system 154 / scale TCP client 810 provides a stream of raw scale samples 815 (e.g., weight values and/or associated timestamps) to a main process / fill coordinator 820. The fill coordinator 820 may continuously ingest the raw samples and evaluate one or more criteria (e.g., weight-change thresholds, dwell-time thresholds, tare-band checks, and/or target-weight criteria) to detect the beginning and end of a fill event.

In some embodiments, the weigh system provides raw scale samples at a first sampling rate (e.g., multiple samples per second) to the fill coordinator and/or database writer. To reduce bandwidth and storage, the system generates downsampled telemetry for persistence in the time-series data store by aggregating a plurality of raw samples over reporting intervals and computing an average (mean) value for each interval, thereby reporting/storing time-series telemetry at a second rate that is lower than the first rate. In some implementations, the system stores both the raw samples and the averaged/downsampled values, and/or stores additional statistics (e.g., min/max/median/standard deviation) for each interval.

As shown, upon detecting a start condition for a fill event, the fill coordinator 820 generates a fill start event 822 that triggers an OCR window for bin identification. In embodiments, the OCR window defines when OCR processing is initiated, enabled, or prioritized relative to a detected fill event (e.g., a time-bounded interval around bin placement and/or early fill) to reduce unnecessary OCR processing outside of fill events.

During the OCR window, the fill coordinator 820 provides image data 823 to an OCR process 830. In the illustrated example, the fill coordinator 820 sends frames and/or region-of-interest (ROI) data via a queue to the OCR process 830. In some embodiments, the ROI corresponds to a cropped portion of a camera frame expected to contain bin-identifying indicia (e.g., serial characters), thereby reducing bandwidth and compute relative to full-frame processing. The queue may be implemented using any suitable inter-process communication mechanism (e.g., an in-memory queue, shared memory, a local message bus, or another buffered transport) and may support backpressure and ordering guarantees appropriate for real-time operation.

The OCR process 830 performs OCR analysis on the received frames/ROIs and generates OCR outputs, which are returned 824 to the fill coordinator 820. As shown, the OCR process 830 may enqueue OCR results (e.g., recognized characters, per-character confidence metrics, bounding boxes, and/or candidate identifiers) for consumption by the fill coordinator 820. In some embodiments, the fill coordinator 820 aggregates multiple OCR outputs across multiple frames and computes a consensus identifier (e.g., by voting, confidence-weighted aggregation, temporal stabilization, or other post-processing) 825. The sequence diagram 800 indicates a “Consensus ID ready” condition, which may correspond to the fill coordinator 820 determining that a bin identifier has sufficient confidence to bind to the active fill event.

After the fill event progresses, the fill coordinator 820 may detect fill completion (e.g., target weight reached and/or a computed rate of change of measured weight over time below a threshold) and generate a fill complete event along with fill metadata. In the illustrated example, the fill complete event and associated metadata are provided 826 to a database writer 840. In embodiments, the fill metadata includes (by way of example and not limitation) the consensus bin identifier, timestamps for fill start and fill completion, net weight added (or other weight-derived metrics), bay identifier, and/or other contextual information used to create a fill record.

The database writer 840 may persist the resulting data and report it to one or more external systems. As shown, the database writer 840 pushes time-series telemetry and a fill record 845 to cloud/data store(s) 850. In some embodiments, the time-series telemetry includes raw and/or downsampled scale measurements over time, while the fill record includes business-level event fields suitable for inventory tracking, auditing, or downstream workflow integration. In some implementations, the cloud/data store(s) 850 include a time-series data store for telemetry and a relational (or structured) data store for fill-event records, although other storage architectures may be used.

In some embodiments, the weigh system provides raw scale samples at a first sampling rate, and the system generates downsampled telemetry by aggregating a plurality of raw samples over reporting intervals and computing an average value per interval, thereby storing/reporting telemetry at a second rate lower than the first rate.

FIG. 8 further illustrates example resiliency behavior for the OCR pipeline. In the illustrated example, an OCR process error condition may be detected and handled using a watchdog behavior in which the fill coordinator 820 initiates a restart of the OCR process 830. In embodiments, restarting the OCR process 830 may include terminating and relaunching the OCR process, reinitializing camera/ROI pipelines, and/or reestablishing queue connections 827, 828, thereby enabling continued operation without requiring a full restart of the scale-ingestion and fill coordination logic. In some examples, the restart logic is triggered based on timeouts, health-check failures, exception conditions, or lack of expected OCR output during an active OCR window.

The sequence diagram 800 is illustrative. In other embodiments, one or more components may be combined or subdivided (e.g., database writer 840 integrated into the fill coordinator 820, or multiple OCR processes 830 instantiated per bay), message ordering may be modified, and additional messages may be used (e.g., explicit acknowledgments, retries, or backpressure signaling).

### Example OCR Pipeline

FIG. 9 illustrates an example OCR pipeline 900 for deriving a bin identifier from image data captured during a fill event. In embodiments, the pipeline 900 may be executed by an OCR process (e.g., the OCR process shown in FIG. 8) and may be activated (or “gated”) during an OCR window triggered by a detected fill-start condition (e.g., as shown in FIG. 7 and FIG. 8).

In the illustrated example, the pipeline 900 begins with frame acquisition 910, in which an OCR camera 142 captures frames (or receives frames from a camera stream). As shown, frame acquisition may be subject to fill-window gating, such that frames are acquired, buffered, and/or forwarded for OCR processing primarily when the system is within a time interval associated with an active fill event (e.g., after bin placement and before completion). This gating can reduce compute utilization and can improve reliability by concentrating OCR effort when the bin label is expected to be present and relevant.

The acquired frames are provided to a preprocessing stage 920. In embodiments, preprocessing may include one or more of: cropping a field-of-view (FOV) or region-of-interest (ROI) expected to contain bin-identifying indicia, resizing to match model input dimensions, normalizing pixel intensity distributions, and/or performing additional image-conditioning operations (e.g., de-noising, contrast enhancement, glare reduction, perspective correction, and/or illumination normalization). Preprocessing 920 can reduce variation in camera placement and lighting conditions and can improve downstream detection and classification performance.

The preprocessed image data is provided to a detection model 930 configured to detect candidate character locations. In some embodiments, the detection model 930 is implemented as a neural-network-based object detector (e.g., a YOLO-type detector), and produces character boxes (e.g., bounding boxes) corresponding to locations within the image that likely contain individual characters of a bin label. In some examples, the detection model 930 outputs, for each box, a location (e.g., x-y coordinates and width/height), a confidence score, and optionally a class indicator (e.g., “character” vs. other detectable objects).

Detected character boxes are passed to a normalize and sort boxes stage 940. In embodiments, stage 940 may normalize box coordinates (e.g., to a consistent coordinate system, scale, or reference ROI), filter boxes based on confidence or size constraints, and then sort the remaining boxes by horizontal position (e.g., left-to-right across the label) to create an ordered sequence corresponding to the expected reading order. In some examples, normalization includes resolving minor rotations or perspective effects so that character ordering is stable across frames.

The ordered character regions are then provided to a per-character classification stage 950. In embodiments, the classification stage 950 uses an OCR classifier (e.g., a convolutional neural network, transformer-based classifier, or other learned model) to classify each character crop into an alphanumeric class and to output associated confidence values. The classifier may output a probability distribution per character, enabling subsequent post-processing to account for uncertain reads (e.g., “O” vs “0,” “I” vs “1,” etc.).

Classification outputs are then provided to a build label string stage 960. In embodiments, stage 960 constructs a candidate label string by concatenating the per-character predictions in the sorted order determined at stage 940. In some examples, stage 960 also retains per-character confidence values, discards low-confidence characters, and/or applies heuristic corrections (e.g., substituting ambiguous characters based on expected formats).

The candidate label string is provided to validate length/format and finalize trigger stage 970. In embodiments, stage 970 validates that the candidate label string satisfies one or more constraints such as an expected string length, an expected character set, an expected prefix/suffix, and/or a known format template for bin identifiers. In some examples, stage 970 asserts a finalize trigger when validation succeeds and/or when a confidence threshold is satisfied (e.g., overall confidence, per-character minimum confidence, repeated matches across frames, or a combination thereof). In some implementations, the finalize trigger indicates that a sufficiently reliable candidate identifier is available for association with the active fill event.

To increase robustness across multiple frames, the output of stage 970 may be provided to a deque buffer and median (or other consensus) stage 980. In embodiments, stage 980 maintains a rolling buffer (e.g., a deque) of recently produced candidate identifiers (and/or their per-character predictions/confidences) and applies a consensus function, illustratively shown as a median operation, to derive a stabilized identifier across time. In practice, the consensus function may be implemented as a median, majority vote (mode), confidence-weighted vote, or other aggregation that reduces the impact of transient misclassifications, motion blur, partial occlusion, or glare in any single frame.

Finally, the pipeline 900 generates an output bin ID 990. In embodiments, the output bin ID 990 includes the selected identifier (and optionally associated metadata such as confidence, timestamp, and/or source camera), and is provided to upstream fill coordination logic (e.g., the fill coordinator of FIG. 8) for binding to the detected fill event and for subsequent record generation and reporting.

FIG. 9 further illustrates an optional QR path 995, labeled as a QR detect + decode fallback or alternative. In embodiments, the QR path 995 operates on the same frames (or ROI) and attempts to detect and decode a QR code when present. As shown, successful QR decoding can produce a decoded ID that is supplied to the output stage 990 (and, in some implementations, may bypass or override the per-character OCR string build/validation path). In some examples, the QR path 995 is executed in parallel with the character-based OCR path, and the system selects between outputs based on availability, confidence, and/or a precedence rule (e.g., prefer QR when decode succeeds; otherwise use character OCR).

The pipeline 900 is illustrative. In other embodiments, additional filtering, confidence scoring, error handling, timeouts, and/or per-bay configuration may be applied (e.g., different expected formats per site, different OCR windows per station, or different ROI definitions).

FIG. 10 illustrates an example annotated OCR frame and consensus identifier determination 1000. In embodiments, FIG. 10 represents an example of how the system (e.g., the OCR pipeline of FIG. 9) derives an ordered sequence of characters from a camera frame and stabilizes the resulting bin identifier across multiple frames using a consensus operation.

In the illustrated example, a frame (OCR camera view) includes a field of view 1010 capturing a bin side region 1020 that contains bin-identifying indicia (e.g., printed or labeled characters). The system may define or select a region-of-interest (ROI) within the frame corresponding to the expected location of the bin label. Within the ROI, the system detects individual character regions (e.g., by generating bounding boxes) and associates each detected character region with a predicted character value and a confidence score.

As shown, the detected characters include the sequence “1 4 5 9 7”, with example per-character confidence values (e.g., 1 (0.98), 4 (0.97), 5 (0.96), 9 (0.95), 7 (0.94)). In embodiments, these confidence values may be produced by a per-character classifier (e.g., an OCR classifier) as probabilities or normalized scores indicating classification certainty. FIG. 10 further illustrates establishing a reading order by sorting character boxes by x-position (e.g., left-to-right across the label), which can be used to assemble an ordered string even when the boxes are detected independently and/or in arbitrary order.

The right-hand portion of FIG. 10 shows example per-frame strings produced from successive frames during an OCR window. In the illustrated example, a first frame yields “14597”, a second frame yields “14597”, and a third frame yields “14527”, which may occur due to transient effects such as motion blur, glare, occlusion, perspective distortion, or a single-character misclassification (e.g., “9” misread as “2”). In embodiments, the system stores a set of these per-frame strings (e.g., in a rolling buffer such as a deque) and computes a consensus identifier based on the buffered outputs. As shown, the consensus output in this example is “14597”, reflecting selection of the most stable/likely identifier across frames (e.g., by majority vote, median/mode selection, confidence-weighted voting, or another temporal aggregation technique).

In embodiments, the consensus identifier output by the process of FIG. 10 is provided as the output bin ID for association with a detected fill event (e.g., for binding to fill metadata and subsequent record generation). FIG. 10 is illustrative, and in other embodiments the system may apply additional constraints, such as expected identifier length/format validation, per-character minimum confidence thresholds, or early-finalization triggers when repeated identical strings are observed.

### Example Workflows

FIG. 11 illustrates an example failure-handling and fallback workflow 1100 for determining a bin identifier during a fill event. In embodiments, the workflow 1100 may be performed by the fill coordinator and/or an OCR process (e.g., as described with respect to FIGS. 7-10) and provides a structured approach for attempting OCR-based identification, falling back to QR decoding when OCR does not finalize, and handling persistent failures via alerts and/or manual entry.

In the illustrated example, the workflow 1100 begins at start fill event 1110. In embodiments, the start fill event 1110 is triggered responsive to detecting a bin placement and/or an initial fill condition based on weight information (e.g., a weight change exceeding a threshold for a dwell time). Upon initiation of the fill event, the system proceeds to run OCR consensus 1120. In embodiments, running OCR consensus 1120 includes acquiring frames during an OCR window, performing per-frame OCR inference (e.g., detection and per-character classification), building per-frame candidate strings, and applying a multi-frame consensus algorithm (e.g., deque buffering with a median/mode or confidence-weighted vote) to determine a stabilized candidate identifier.

The workflow 1100 includes a decision point that determines whether the OCR finalized, and optionally whether the string is of valid length and format. 1130. In embodiments, the OCR-finalized determination includes checking whether the OCR pipeline has produced a candidate identifier meeting one or more finalization criteria, such as satisfying an expected length, matching an expected format template (e.g., allowable character set, prefix/suffix constraints, checksum constraints, etc.), and/or satisfying one or more confidence or repeatability thresholds (e.g., the same string observed in N consecutive frames or exceeding an aggregate confidence threshold). When the decision at 1130 is YES, the system proceeds to generate bin ID 1140. In embodiments, generating the bin ID 1140 includes outputting the consensus identifier (and optionally associated metadata such as confidence and timestamp) for association with the active fill event and for use in fill record creation and reporting.

When the decision at 1130 is NO (e.g., OCR does not finalize within a configured time, yields invalid length/format, or otherwise fails to meet acceptance criteria), the workflow 1100 proceeds to a fallback path: QR detect / decode 1150. In embodiments, QR detect/decode 1150 includes executing a QR detection and decoding routine on one or more frames (or an ROI) captured during the OCR window. The workflow then evaluates whether the QR is decoded 1160. When the decision at 1160 is YES, the system proceeds to use QR value as bin ID 1170. In embodiments, the QR value may be used directly as the bin identifier, may be mapped to a canonical identifier (e.g., via a lookup table), and/or may be validated according to expected constraints prior to association with the fill event.

When the decision at 1160 is NO (e.g., QR code not present, not detected, or not decodable), the workflow 1100 proceeds to manual entry / unknown bin record + alert 1180. In embodiments, this step includes generating an “unknown bin” record and issuing an alert for operator intervention, such as prompting a user interface for manual bin ID entry, flagging the fill record for later reconciliation, and/or notifying a supervisory system.

FIG. 11 further illustrates an example error-recovery branch associated with the OCR process. In the illustrated example, an OCR process error may be detected during or prior to the OCR consensus operation 1120. Responsive to such an error, the system may perform log error 1190 and then restart OCR process 1192. In embodiments, restarting the OCR process 1192 may be performed by a watchdog routine and may include relaunching the OCR process, reinitializing camera interfaces, and/or reestablishing inter-process queues. As shown, after restart the system may retry OCR (e.g., return to run OCR consensus 1120) to attempt successful identification before or during the remainder of the fill event.

The workflow 1100 is illustrative, and in other embodiments additional branches, timeouts, and escalation policies may be employed (e.g., multiple OCR retries before QR fallback, prioritization rules between OCR and QR outputs, or site-specific validation templates) while remaining within the scope of the present disclosure.

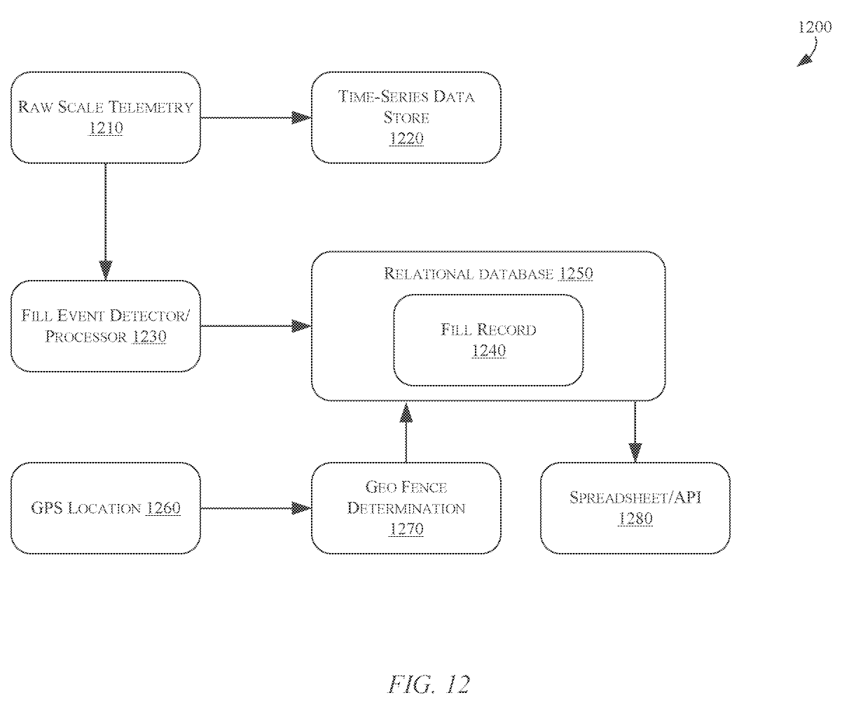

FIG. 12 illustrates an example data plane and storage/reporting architecture 1200 for capturing raw weigh-system telemetry, detecting fill events, generating fill records, enriching fill records with location-derived context (e.g., geofence results), and exporting records to external systems.

In the illustrated example, raw scale telemetry 1210 is produced by a weigh system (e.g., scale samples comprising weight values and timestamps). The raw scale telemetry 1210 may be provided to a time-series data store 1220 for persistence of the telemetry stream (e.g., for audit, troubleshooting, and/or downstream analytics). In addition, the raw telemetry stream is provided to a fill event detector/processor 1230. In embodiments, the fill event detector/processor 1230 evaluates the telemetry stream to detect fill events (e.g., start/end times and net weight), and to generate event metadata such as a fill event identifier, a bin identifier (e.g., from the OCR pipeline described above), weights, and timestamps.

As shown, the fill event detector/processor 1230 outputs a fill-event payload (e.g., fill event + ID + weight + timestamps) to a fill record 1240 abstraction that represents a structured event record suitable for storage and querying. In the illustrated example, fill records are persisted in a relational database / fill records store 1250. In embodiments, the relational database 1250 stores one or more tables (or analogous data structures) that include, for each fill event, the bin identifier, event timestamps, weight-derived metrics, and other metadata. FIG. 12 also depicts interaction between the fill record 1240 and the relational database 1250, which may represent writing the fill record into the database and/or retrieving a stored fill record for further enrichment, validation, or export.

FIG. 12 further illustrates optional location enrichment. A GPS/location component 1260 provides location samples (e.g., latitude/longitude with timestamps) to a geofence determination component 1270. In embodiments, the geofence determination component 1270 determines whether the system is located within a predefined geographic region (e.g., a customer site, yard, loading area, or other geofenced zone), and outputs a geofence result (e.g., geofence ID, in/out state, confidence, and/or timestamp). As shown, the geofence result is provided to the fill record 1240 so that the fill record includes location-derived context (e.g., associating a fill event with a site or operational zone).

Finally, FIG. 12 depicts an example export interface, shown as spreadsheet / API 1280. In embodiments, the spreadsheet/API 1280 provides access to stored fill records (and, in some implementations, associated telemetry) via export and/or query interfaces. As illustrated, the relational database/fill records store 1250 can export fill records to the spreadsheet/API 1280, enabling downstream reporting workflows (e.g., spreadsheet exports for reconciliation, dashboards, or integration into enterprise systems).

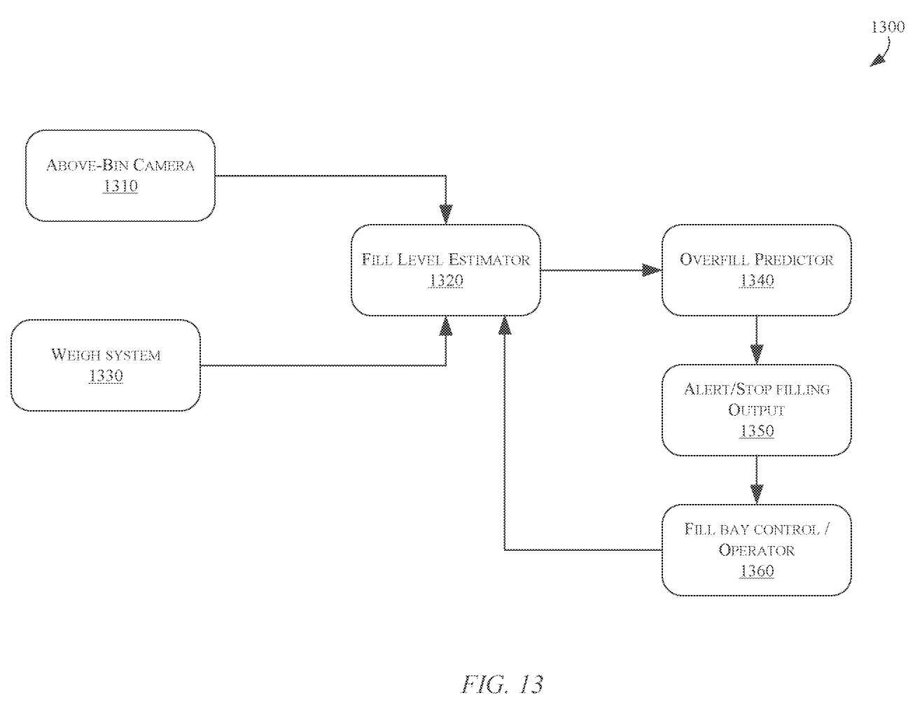

FIG. 13 illustrates an example overfill prevention loop 1300 that uses an above-bin vision signal (and optionally scale information) to estimate fill level, predict time-to-overfill, and generate alerts and/or stop-filling outputs during an active fill operation.

In the illustrated example, an above-bin camera 1310 captures images of the interior of a bin (or a region proximate the bin opening) during filling. Image data from the above-bin camera 1310 is provided to a fill level estimator 1320. In embodiments, the fill level estimator 1320 uses segmentation and/or depth estimation to determine a measure of fill level (e.g., a surface height, a fill fraction, percent capacity, freeboard distance, or other level proxy). The fill level estimator 1320 may operate continuously or periodically during filling.

FIG. 13 also depicts optional sensor fusion with a weigh system 1330. In embodiments, weight information from the weigh system 1330 is provided to the fill level estimator 1320 (or to a downstream predictor) to improve robustness, such as by correlating visual fill level with mass flow, smoothing noisy visual estimates, detecting abnormal conditions (e.g., bridging, voids, or camera occlusion), and/or calibrating level-to-capacity relationships.

The output of the fill level estimator 1320 is provided to an overfill predictor 1340. In embodiments, the overfill predictor 1340 computes one or more predictive metrics, such as time-to-full, percent capacity, and/or a trend in fill rate. Based on these predictions, the overfill predictor 1340 provides a control or notification signal to an alert/stop filling output 1350. In embodiments, the alert/stop filling output 1350 may include a visual alarm, audible alarm, HMI indication, and/or a machine-interlock or control output configured to stop or slow filling.

As shown, the alert/stop filling output 1350 is provided to a fill bay control/operator 1360, which may represent a human operator, an automated bay controller, or a combination thereof. The dashed feedback path labeled repeat during filling indicates that the estimation and prediction steps may be repeated iteratively throughout the fill operation, thereby continuously updating the predicted overfill condition and maintaining timely alerts or stop-filling commands as conditions change.

Having identified various components in the present disclosure, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions, etc.) can be used in addition to or instead of those shown.

The subject matter of the present disclosure is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms "step" and/or "block" may be used herein to connote different elements of methods employed, the terms should not be interpreted as implying any particular order among or between various steps herein disclosed unless and except when the order of individual steps is explicitly described. For purposes of this disclosure, words such as "a" and "an," unless otherwise indicated to the contrary, include the plural as well as the singular. Thus, for example, the requirement of "a feature" is satisfied where one or more features are present.

The present disclosure has been described in relation to particular embodiments, which are intended in all respects to be illustrative rather than restrictive. Alternative embodiments will become apparent to those of ordinary skill in the art to which the present disclosure pertains without departing from its scope.

From the foregoing, it will be seen that this disclosure is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A computer-implemented method of operating a bin filling system, the method comprising:
detecting a fill event associated with a bin positioned within a filling bay based on weight information from a weigh system;
receiving a plurality of image frames captured by a camera positioned adjacent to the bin and associated with the filling bay;
generating bounding boxes around characters detected on the bin by inputting the plurality of image frames into a first machine learning model;
predicting labeled characters within each of the bounding boxes by inputting a section of the plurality of image frames associated with each of the bounding boxes into a second machine learning model;
concatenating the labeled characters into a label string;
queueing label strings into a deque data structure over a period;
determining a consensus identifier for the bin based on the label strings in the deque data structure; and
generating a predicted serial number for the bin using the consensus identifier.

2. The method of claim 1, wherein detecting the fill event comprises detecting a weight change indicating the bin has been positioned within the filling bay.

3. The method of claim 1, wherein detecting the fill event comprises determining that a measured weight is within a predetermined tare-weight range and, responsive thereto, performing a tare-to-zero operation before a filling sequence begins.

4. The method of claim 1, further comprising determining completion of the fill event based on at least one of (i) a predetermined target weight or (ii) image-based fill level, and generating at least one of a stop-filling alert or a control output associated with the filling bay.

5. The method of claim 1, wherein concatenating the labeled characters into the label string comprises ordering the labeled characters based on respective spatial positions of the bounding boxes in an image frame.

6. The method of claim 1, wherein the deque data structure stores label strings from successive frames of a continuous image stream captured during the fill event.

7. The method of claim 1, wherein determining the consensus identifier comprises calculating median values for the labeled characters across character positions in the deque data structure.

8. The method of claim 1, further comprising validating the label string against an expected length or format and, when an inconsistency is detected, performing at least one of reclassification, additional checks, or triggering manual intervention.

9. The method of claim 1, wherein the first machine learning model is trained using augmented training images including at least one of lighting variation, rotation, noise, debris, or damage to bin markings.

10. The method of claim 1, further comprising detecting a QR code on the bin and decoding the QR code to obtain at least a portion of the predicted serial number.

11. A bin detection and analysis system comprising:
a weigh system associated with a filling bay;
at least one camera positioned adjacent to the filling bay;
one or more processors and memory storing instructions that cause the one or more processors to:
detect a fill event based on weight information from the weigh system;
receive image frames from the at least one camera;
generate bounding boxes around characters on a bin using a first machine learning model;
predict labeled characters using a second machine learning model;
generate label strings;
queue the label strings into a deque;
determine a consensus identifier for the bin based on the label strings queued into the deque; and
output a predicted serial number for the bin based on the consensus identifier.

12. The system of claim 11, wherein the system includes a control box and a fill bay control box in communication with a cloud environment over at least one of a wired or wireless network.

13. The system of claim 11, wherein the at least one camera comprises at least one of an OCR camera, an above-bin inspection camera, a floor camera, or a truck camera.

14. The system of claim 11, wherein the instructions cause execution of an OCR process separate from a main scale-ingress process, the OCR process sending detected characters to the main scale-ingress process via a queue, and restarting the OCR process responsive to an error condition.

15. The system of claim 11, further comprising generating a fill record associated with the fill event and storing (i) time-series data in a time-series data store and (ii) fill records in a relational data store, the fill record further including a geofence determination based on GPS information.

16. A non-transitory computer-readable medium storing instructions that, when executed, cause one or more processors to:
detect a fill event associated with a bin positioned within a filling bay based on weight information from a weigh system;
receive a plurality of image frames captured by a camera positioned adjacent to the bin and associated with the filling bay;
generate bounding boxes around characters detected on the bin by inputting the plurality of image frames into a first machine learning model;
predict labeled characters within each of the bounding boxes by inputting a section of the plurality of image frames associated with each of the bounding boxes into a second machine learning model;
concatenate the labeled characters into a label string;
queue label strings into a deque data structure over a period;
determine a consensus identifier for the bin based on the label strings in the deque data structure; and
generate a predicted serial number for the bin using the consensus identifier.

17. The non-transitory computer-readable medium of claim 16, wherein the instructions cause weight data to be sampled at a first rate and reported to a time-series data store at a second rate based on averaging a plurality of samples.

18. The non-transitory computer-readable medium of claim 16, wherein the instructions further cause estimating a fill level of the bin based on image frames from an above-bin inspection camera and generating an overfill prevention alert.

19. The non-transitory computer-readable medium of claim 16, wherein the instructions further cause detecting a forklift and a human within image frames captured by a floor camera and generating an unsafe-condition alert based on a proximity criterion.

20. The non-transitory computer-readable medium of claim 16, wherein the instructions further cause detecting a truck identifier using image frames captured by a truck camera and generating a delivery record including the truck identifier and delivery details.
